(19) United States
(12) Patent Application Publication
(10) Pub. No.: US 2017/0332714 A1
(43) Pub. Date: Nov. 23, 2017

(54) GRIP SURFACES

(71) Applicant: Ansell Limited, Richmond (AU)

(72) Inventors: Janeth Rubi Herrera Gutiérrez, Juarez (MX); Nestor David Balleza Espinoza, Ciudad Juarez (MX); Miguel Angel Sanchez Gonzalez, Ciudad Juarez (MX); Agustin Portillo Mercado, Ciudad Juarez (MX)

(21) Appl. No.: 15/589,138

(22) Filed: May 8, 2017

Related U.S. Application Data
(60) Provisional application No. 62/337,480, filed on May 17, 2016.

(51) Int. Cl. A41D 19/015; B29C 67/06; B29C 35/02; B29C 41/14; D06N 3/00; B29L 31/48; B29K 105/04

(52) U.S. Cl. CPC A41D 19/01547; B29C 41/14; B29C 67/06; D06N 3/0043; B29C 35/02; B29K 2105/04; D06N 2205/04; D06N 2205/24; B29L 2031/4864

(57) ABSTRACT

Provided among other things is a method of forming a composite glove with a grip texture, comprising: (a) providing a coagulant-coated support layer that is a fabric layer or a polymeric layer; (b) dip applying to the support layer a foamed polymer dispersion comprising about 0.5% to about 2.0% by weight hygroscopic agent; (c) allowing a portion of the applied foamed polymer dispersion to coagulate based the coagulant diffusing from the support layer to form a partially coagulated foam layer; (d) washing the partially coagulated foam layer to remove uncoagulated polymer to form a coagulated foam layer; and (e) vulcanizing the coagulated foam layer to form a vulcanized open foam layer laminated to the support.

This application claims the priority of U.S. Ser. No. 62/337,480, filed May 17, 2016.

The present application relates generally to polymeric grip surfaces on a support layer, and method of obtaining the same.

It is well known that a foamed latex (polymer dispersion) can be applied to a substrate to which a coagulant has been directly applied, and the foam will begin to coagulate (gel) starting from its contact surface with the substrate, locking in some element of foam structure at the bottom portion of the applied foam. See for example U.S. Pat. No. 2,434,035 and EP1608808. One can select the time over which the coagulation action can extend upwards into the applied foam, and then wash out the uncoagulated applied foam. Depending on how stable the foam structure is in the applied foam, and the time allowed for coagulation, the more coagulated foam structure is exposed by the wash out. Since the top of a given exposed foam bubble may not be strong enough or coagulated enough to survive the wash and subsequent vulcanization, the foam can be open from the top. Similarly, and depending for example on the level of aeration of the foam, the foam can be interiorly open.

Disclosed here is a method of stabilizing the foam to better assure a robust foam structure with good grip properties is obtained. Forming the foam requires lowering the surface tension with a surfactant, and mechanical aeration. It has been found that addition of a hygroscopic agent increase the stability of the foam in an un-gelled state. Without being bound by theory, it is believed that the hygroscopic agent increases the availability of water, thus increasing the quantity of hydrogen bonds, which stabilizes the bubbles in the latex.

### SUMMARY

Provided among other things is a method of forming a composite glove with a grip texture, comprising: (a) providing a coagulant-coated support layer that is a fabric layer or a polymeric layer [which can be a fabric layer laminated to an outer polymeric layer (which can comprise multiple dipped polymer coatings)]; (b) dip applying to the support layer a foamed polymer dispersion comprising about 0.5% to about 2.0% by weight hygroscopic agent; (c) allowing a portion of the applied foamed polymer dispersion to coagulate based the coagulant diffusing from the support layer to form a partially coagulated foam layer; (d) washing the partially coagulated foam layer to remove uncoagulated polymer to form a coagulated foam layer; and (e) vulcanizing the coagulated foam layer to form a vulcanized open foam layer laminated to the support.

### DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only illustrative embodiments of this invention and are therefore not to be considered limiting of its scope, for the invention may admit to other equally effective embodiments.

FIG. 1 depicts a process flow chart;

FIG. 2 is a blown-up top view of a structure obtained by the process, formed on top of a liquid resistant polymer layer;

FIG. 3 is another blown-up top view of a structure obtained by the process, formed on top of a liquid resistant polymer layer;

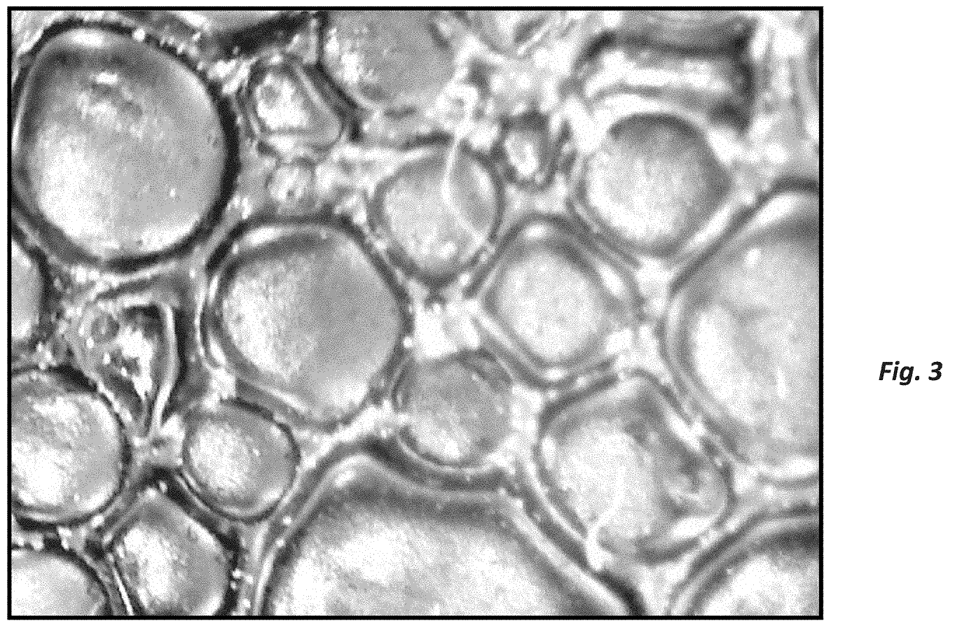

FIG. 4 is a blown-up top view of a grip surface formed by a salt process pursuant to U.S. Pat. No. 7,771,644; and

FIG. 5 is another blown-up top view of a structure obtained by the process of then invention, including three bars showing the dimensions of surface cavities (91 micrometer, 126 micrometer, 110 micrometer, going from bottom marking up and to the right).

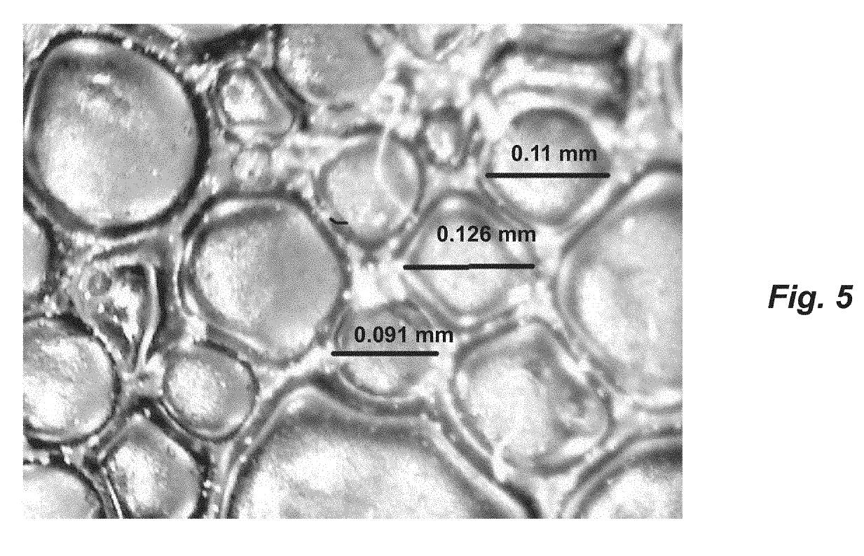

To facilitate understanding, identical reference numerals have been used, where possible, to designate comparable elements that are common to the figures. The figures are not drawn to scale and may be simplified for clarity. It is contemplated that elements and features of one embodiment may be beneficially incorporated in other embodiments without further recitation.

### DETAILED DESCRIPTION

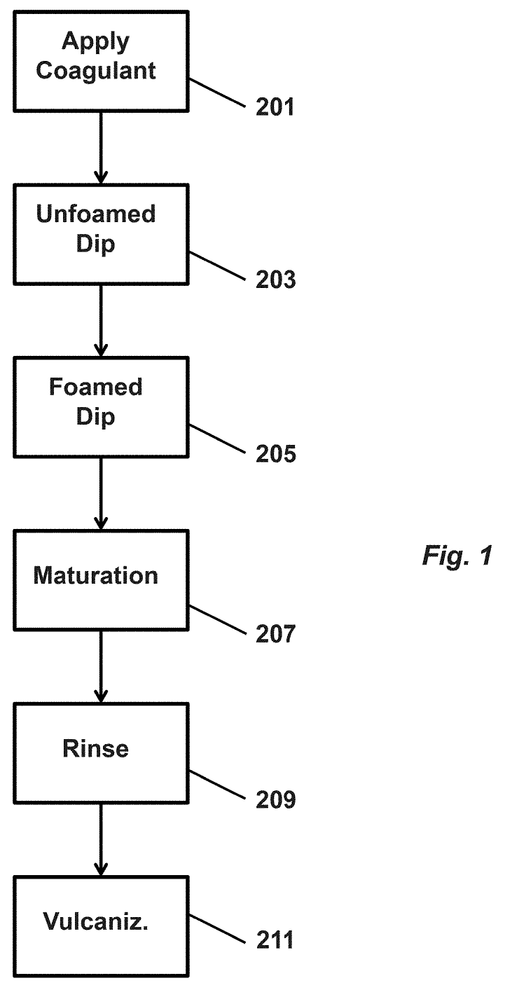

The process begins with Step 201 (FIG. 1), in which a solution of coagulant is applied to a liner—i.e., a fabric shell for a rubberized article. Thereafter (not shown), the coagulant can be dried onto the liner, such as in a 65° C. oven. The drying can be conducted with a drip down orientation followed by a drip up orientation. Typically, the liner will be processed while dressed on a “former,” a solid piece approximately shaped like the article to be made.

In Step 203 the liner is dipped in polymeric particle dispersion (latex), preferably unfoamed. For example, where the article is a glove, the liner can be palm dipped (to cover, the palm, palm side of the fingers, and a portion of the finger tips) or ¾ dipped (to cover the palm and the fingers). Thereafter (not shown), the excess polymeric particle dispersion can be allowed to drip off, for example using a drip down orientation for about 10 seconds. While a single dip can be useful, two or more dips may be used, typically forming a layer of polymer.

In Step 205, the coated liner is dipped in foamed polymeric particle dispersion. The foamed polymeric particle dispersion includes a hygroscopic agent such as glycerin, as described below. Thereafter (not shown), the excess polymeric particle dispersion can be allowed to drip off, for example using a drip down orientation. The dipping is typically configured to be substantially coextensive with, or within, the area of the first dip. By “substantially coextensive” it is meant that the boundaries differ by no more than about 4 mm. In embodiments, the boundaries differ by no more than about 2 mm, or about 1 mm.

In Step 207, the coated liner is allowed to mature such that the rib structure of interior foam cavities is locked in place by coagulation stemming from the coagulant initially applied to the liner. (The “ribs” are the structurally stronger portions of the foam, as in the ribs of a gothic cathedral.) In other words, the delay (maturation) between Step 205 and Step 209 (Rinse) is selected to arrive at the desired residual foam structure that is exposed by the rinse. During the maturation step the exterior of the foam may begin to collapse. The former can be positioned to allow excess latex, including collapsed foam, to drip off. The hygroscopic agent is believed to stabilize the bubbles (size and amount of bubbles presented in the polymeric dispersion). Background information on foams can be found at Exerowa & Kryglyakov, “Foam and Foam Films: Theory, Experiment, Application,” 1998, Elsevier.

In Step 209, a rinse is applied. In embodiments, the rinse is with one or more sprayers. Rinse force should be enough to remove enough uncoagulated latex to expose a surface of coagulated foam The rinse thus exposes a foamed polymeric layer.

In Step 211, the coated liner is vulcanized. In embodiments, the coated liner is leached to minimize processing chemicals and/or proteins.

Thereafter, typically, the article is removed from the former.

The liner can be a knitted or woven material, or sewn together from non-woven material. For example, the liner can be derived from many fibers and/or filaments, such as cottons, rayons, nylons, polyesters, and the like and may further comprise elastomeric materials (e.g., natural or synthetic rubber), such as SPANDEX® may also be included, whether as a main yarn or plaited within the main yarn, for comfort and enhanced fit. Additionally, the knitted fabric liner may comprise high performance yarns, such as high-performance polyethylene (HPPE). In some embodiments, yarns comprise cut resistant yarns, such as, but not limited to, steel wire, glass fibers, carbon fibers and filaments, ultra-high molecular weight polyethylenes, nylons, p-aramids, m-aramids, aliphatic nylons, aromatic nylons, NOMEX® (m-aramid), TWARON® (p-aramid), KEVLAR® (p-aramid), DYNEEMA® (high-performance polyethylene), SPECTRA® (high-performance polyethylene), VECTRAN® (aromatic polyester that is a liquid crystal polymer), and the like or any composite or blend of the fibers and materials. Furthermore, fabric liners comprise, for example, a composite yarn including at least one core yarn and at least one wrapping yarn as disclosed in commonly-assigned U.S. Pat. No. 8,074,436, which is herein incorporated by reference in its entirety. At least one exemplary blended yarn according to the invention comprises a cut-resistant composite yarn comprising 90% HPPE and 10% glass fiber, which is gel, wet, or dry spun into a core yarn and is subsequently wrapped with, for example, 2×-50 denier polyamide wrapping yarns (such as nylon 66). Similarly, a blended yarn according to the invention comprises a composite yarn that includes, for example, a 160 denier filament of 90% HPPE and 10% mineral fibers, e.g., basalt and/or glass fibers that are gel, wet, or dry spun to form a core yarn and wrapped with a 2×-50 denier polyamide wrapping yarn, resulting in a 289 dtex composite yarn. Furthermore, any wrapping yarn may favorably be, for example, 30 denier to 140 denier or any denier. Therefore, a core yarn or filament comprising 90% HPPE and 10% glass fibers having, for example, 140-221 denier, and wrapped with a 2×-40, 2×-50, 2×-60, or 2×-70 to 2×-140 denier polyamide and/or polyester wrapping yarns are contemplated herein.

The polymeric layers (foamed or unfoamed) may be natural rubber polymeric particle dispersion (including Guayule latex), synthetic rubber polymeric particle dispersion, or the like, and combinations thereof. The synthetic rubber polymeric particle dispersion may be selected, for example, from the group comprised of polychloroprene, acrylonitrile butadiene copolymer (NBR) (such as carboxylated acrylonitrile butadiene copolymer, such as highly carboxylated acrylonitrile butadiene copolymer), polyisoprene, polyurethane (PU), styrene-butadiene, butyl, and combinations thereof. A useful nitrile composition is Synthomer 6322 (45% solids content; aqueous, colloidal dispersion of carboxylated butadiene-acrylonitrile copolymer with a medium acrylonitrile level (˜25-30%); Synthomer LLC, Atlanta, Ga.).

In embodiments, polymeric particle compositions may have commonly used stabilizers such as potassium hydroxide, ammonia, sodium salts, ethoxylated nonphenol, ethoxylated tridecyl alcohol, sulfonates and the like. In embodiments, the polymeric particle compositions may contain other commonly used ingredients such as surfactants, anti-microbial agents, fillers/additives and the like. In embodiments, the polymeric particle compositions used to form the unfoamed polymeric layer has a viscosity in the range of for example about 500-8000 centipoises, such as about 4500 to about 5500 centipoises. In embodiments, the polymeric particle compositions used to form the foamed polymeric layer has a viscosity in the range of for example about 400 centipoises, such as about 1,000 centipoises.

Embodiments according to the invention further include in the polymeric layer vulcanizing agents and activators, such as zinc oxide, ZDEC and sulphur, as are known to those of skill in the art. Particle fillers, i.e., reinforcement fillers, such as boron carbide and/or silicon carbide and/or, aluminum potassium silicates, such as mica, and/or aluminum oxide may be employed to improve the abrasion resistance of coatings formed from the polymeric compositions. Useful additives include for example MB2 E.S. (Akron Dispersions, Akron, Ohio), a mixture of zinc oxide and Sulphur, and Aquablack 7905 (Solution Dispersions, Twinsburg, Ohio), a carbon black-based pigment.

Foamed or unfoamed polymeric layers can be used in the texture-providing layers. Foam polymer formulations can comprise elastomer, stabilizer, curative agent, and optionally foaming agent, one or more of thickening agent (e.g., MHPC), flow modifier, pigment(s), and the like. Wax or filler additives may be added. For a foamed polymeric layer, the air content in the composition can be for example in the about 50 to about 80% range, such as the about 60 to about 70% range on a volume basis (air-added volume/(initial+added volume)×100%). [Typically, the density is 1 g/cm³, so the measurement can be made by weight, and equates to by volume.] For example, an air content of about 70% can be used. Once a composition is foamed with the desired air content and the viscosity is adjusted as appropriate, refinement of the foamed composition can be undertaken by for example stirring the composition with an impeller driven at a fast speed and using a different impeller run at a reduced speed to refine the bubble size as is known to those of skill in the art. Methods for incorporating high air contents are described in Woodford et al., U.S. Pat. No. 7,048,884, which is commonly-assigned and incorporated herein in its entirety.

Useful surfactants for providing the foaming include for example Calsoft L60, a sodium linear alkyl benzene sulfonate (believed to be dodecyl benzene sulfonate) (Pilot Chemical Co., Cincinnati, Ohio). It can be used as an aqueous solution thereof marketed by Pilot as Calsoft M120. Useful surfactants include anionic surfactants, including alkyl benzene sulfonates.

If the volumetric air content in the latex phase is in the range of about 15-70% in a foamed coating, the air cells tend to be adjacent to each other and expand during a vulcanization heating step and touch each other, and merge. This process creates open-celled foams having an intra-foam network of cells in fluid communication with each other. Therefore, open-celled foams absorb liquids, such as oils and water, into an internal matrix. For example, if a drop of liquid is placed on a glove in the palm portion, the liquid penetrates the polymeric coating cells, as opposed to a closed-celled foam, which is impervious to liquids.

Foamed or unfoamed polymeric compositions having higher viscosity may not penetrate the interstices between the yarns in the knitted liner and, if so applied, may require a higher depth of immersion of a former having a dressed knitted liner. Also, the air cells in the foamed polymer can reduce the modulus of elasticity of the coating made from the polymeric composition, increasing the flexibility of the glove.

The coagulant composition can be for example a solution or suspension of a salt-based coagulant, such as a calcium salt (such as calcium nitrate) or an acid-based coagulant. For example, the coagulant composition can be about 5% calcium nitrate in water.

The advantages of the invention are obtained by adding a hygroscopic agent that has the effect of reducing surface tension. The hygroscopic agent can be a mixture of hygroscopic compounds. Examples include glycerin and other polyhydroxylated compounds of H, O and C where hydroxyls are 3 or more, the ratio of hydroxyls to carbon is 3 to 4 (3:4) or higher, and the number of carbons is 3 to about 12. The amount of hygroscopic agent added can be, for example, as to comprise from about 0.5% to about 2.0% of the weight of the polymeric particle composition (as weighed prior to foaming).

Typically, the hygroscopic agent is added before or after initial foaming of the polymeric particle dispersion, such as during the initial part of the foaming process.

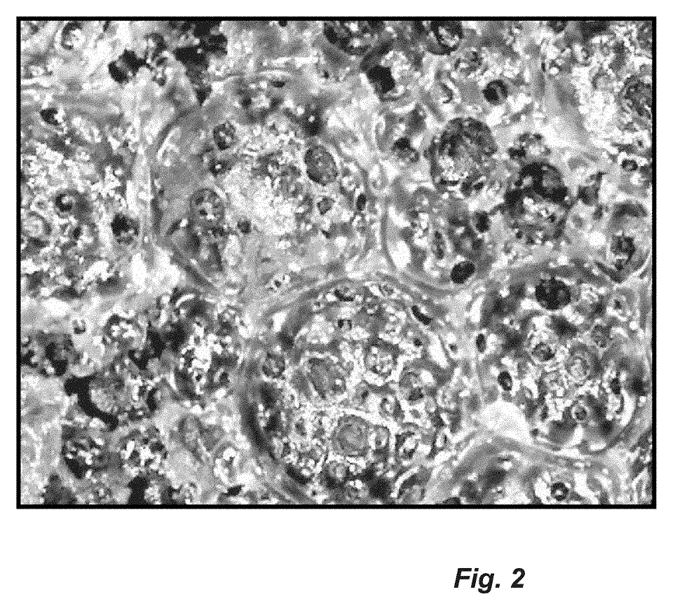

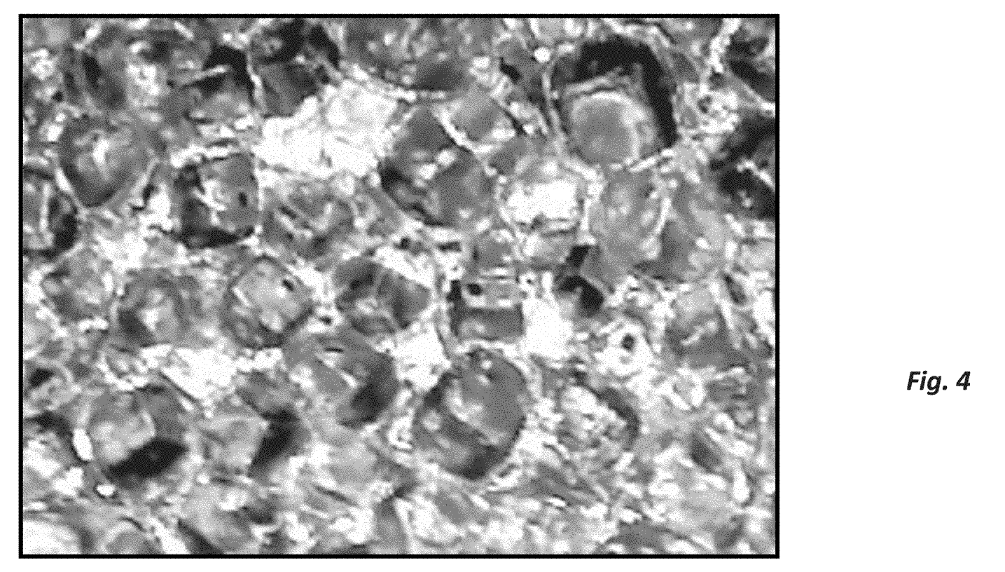

Generally, the surface rims of the open surface cavities provided by the method described here are more circular in aspect that cavities created by contacting with salt pursuant to U.S. Pat. No. 7,771,644 (See FIG. 4). The rims are in fact often polyhedral (made up of many straight lines). Thus, polyhedral but near circular. Moreover, the surface cavities can be filled with cavities that extend into the interior of the foam. See, FIG. 2.

In embodiments, the average size of the surface cavities (defined by the surface rims of the cavities) after vulcanization is in the range of about 500 to about 1000 micrometers, such as about 600 to about 900 micrometers.

It has been found that liner-supported gloves can achieve good grip using polymer coatings (e.g., unfoamed layer, foamed layer for grip) that are about the same or thinner than has been obtained with the salt method of forming texture according to U.S. Pat. No. 7,771,644. For example, polymer coating thicknesses from about 8 mil (0.2 mm) to about 40 mil (1 mm) can be used. Typically thicker coatings are used with thinner liner thicknesses.

Articles that can be made according to the invention include, for example, glove, footies (slippers), finger cots, sleeves or coverings to be adhered to any surface needing slip resistance, and the like.

The grip of the surfaces made by the claimed method can be measured in gloves incorporating the surfaces by Method B, set forth below.

Using method set forth below, and a nylon liner, dry grips that are about 90 lb/in or better can be achieved. Oil grips of about 14 lb/in or better can be achieved, even about 50 lb/in or better can be achieved. Wet grips of about 40 lb/in or better can be achieved, even about 80 lb/in or better can be achieved.

Using method set forth below, and a Kevlar liner, dry grips that are about 65 lb/in or better can be achieved. Oil grips of about 12 lb/in or better can be achieved. Wet grips of about 35 lb/in or better can be achieved.

### Principle of the Test Method

Method B uses a 1.0 kg or 1.5 kg weight (e.g., metallic), and measures “Pull Force” needed to grip test bar for lifting the weight, and a “Catch Force” needed to re-grip the test bar after letting it slip.

The method is used to measure the pinch grip performance of glove in grip force (kgf) in a systematic pattern of a pinch grip task. The subject uses only the tips of the first finger and thumb to grip the grip bar. Sufficient grip force between the finger and thumb is required to enable the grip bar to be held in control so that it can then be pulled down in a fixed distance without slipping (“Pull Force”). The pulling down action effectively lifts a specific mass (1.0 kg or/and 1.5 kg) on the other side of a pulley. The grip bar is then released, allowed to slip and then re-gripped (“Catch Force”). Finally the grip bar is returned to the stationary initial position in a controlled manner. The grip bar is wetted with water or covered with oil when performing wet or oil pinch grip test respectively.

TABLE B
Test Procedure

General
a) Apply minimum grip force around a grip bar which is sufficient to lift
up a certain load.
b) The tester shall use only the tips of the first finger and thumb to grip the
grip
c) Preferably use the same size and same side of gloves when conducting
the test.
d) The tester shall perform the test by using the dominant hand.
e) The wrist shall be rested on a support (e.g., the lower height indicator
block) when re-gripping the slipping grip bar.
Test Procedure - Dry
a) 2 × 500 g standard weights are slotted onto the mass-holder to provide a
1.0 kg load.
b) The grip bar is cleaned with ethanol and dried to remove any
contamination.
c) The tester shall follow the procedure in Table C (below).
d) Repeat Table C steps until three repetitions have been performed for the
same glove specimen.
e) 3 × 500 g standard weights are slotted onto the mass-holder to provide a
1.5 kg load.
f) Repeat Table C steps for lifting up the load of 1.5 kg and until three
repetitions have been performed for the same glove specimen.
g) Unless otherwise specified, two tests on each sample should be carried
out.
Test Procedure - Wet
The same procedure is repeated, but adding the following after step b):
b-1) Approximately 1.0 ml of water is dripped onto a gauze using a
pipettor.
b-2) Both sides of the grip bar are then wiped with the wetted gauze.
Test Procedure - Oil
The same procedure is repeated, but adding the following after step b):
b-1*) Approximately 1.0 ml of oil (Shell Rimula X 15W-40) is dripped
onto a gauze using a pipettor.
b-2*) Both sides of the grip bar are then wiped with the wetted gauze.

TABLE C

| Task | Action |
|---|---|
| 1 | Tester uses only the tips of the first finger and thumb to |
| | grip the grip bar at the pre-marked position |
| | The gloved hand applies just sufficient grip force to pull |
| | the grip bar down vertically |
| 2 | The gloved hand's wrist reaches the lower height |
| | indicator and stops |
| | Tester releases grip allowing the grip bar to slip through |
| | the fingers whilst keeping the wrist at the lower height |
| | indicator |
| 3 | Tester re-grips grip bar and stops its movement whilst |
| | keeping the wrist at the lower height indicator |
| | Tester moves grip bar up vertically |
| 4 | Tester releases grip when the grip bar reaches its initial |
| | stationary position |

All ranges recited herein include ranges therebetween, and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4 or more, or 3.1 or more. If there are two ranges mentioned, such as about 1 to 10 and about 2 to 5, those of skill will recognize that the implied ranges of 1 to 5 and 2 to 10 are within the invention.

A laminate is a bonding, fusing, adhesion, or the like between polymer layers, or between polymer and fabric layers, such that in the range of anticipated use the laminate is a unitary structure. A unitary structure cannot be separated except by extreme actions such as cutting. Especially after vulcanization, the polymer layers described are laminates, as are the liner—polymer layers described.

Where a sentence states that its subject is found in embodiments, or in certain embodiments, or in the like, it is applicable to any embodiment in which the subject matter can be logically applied.

The invention can be further described with reference to the following numbered A Embodiments:

### Embodiment A1

A method of forming a composite glove with a grip texture, comprising: (a) providing a coagulant-coated support layer that is a fabric layer or a polymeric layer [which can be a fabric layer laminated to an outer polymeric layer (which can comprise multiple dipped polymer coatings)]; (b) dip applying to the support layer a foamed polymer dispersion comprising about 0.5% to about 2.0% by weight hygroscopic agent; (c) allowing a portion of the applied foamed polymer dispersion to coagulate based the coagulant diffusing from the support layer to form a partially coagulated foam layer; (d) washing the partially coagulated foam layer to remove uncoagulated polymer to form a coagulated foam layer; and (e) vulcanizing the coagulated foam layer to form a vulcanized open foam layer laminated to the support.

### Embodiment 2

The method of an A Embodiment, wherein the support comprises a fabric, and the method further comprises: (al) dip applying to the fabric a second polymer dispersion configured to provide a water resistant polymer layer, and thereafter dip applying the foamed polymer dispersion.

### Embodiment 3

The method of an A Embodiment utilizing a fabric, wherein the fabric comprises nylon.

### Embodiment 4

The method of Embodiment 3, wherein the composite glove provides a dry grip of about 90 lb/in, an oil grip of about 14 lb/in, and a wet grip of about 40 lb/in or better.

### Embodiment 5

The method of Embodiment 3, wherein the composite glove provides a dry grip of about 90 lb/in, an oil grip of about 50 lb/in, and a wet grip of about 80 lb/in or better.

### Embodiment 6

The method of an A Embodiment, wherein the water resistant polymer layer and the vulcanized open foam layer comprise NBR.

### Embodiment 7

The method of an A Embodiment utilizing a fabric, wherein the fabric is cut resistant and comprises an aromatic nylon.

### Embodiment 8

The method of Embodiment 6, wherein the composite glove provides a dry grip of about 65 lb/in, an oil grip of about 12 lb/in, and a wet grip of about 35 lb/in or better.

### Embodiment 9

The method of one of Embodiments 7 or 8, wherein the fabric comprises an p-aramid nylon.

### Embodiment 10

The method of an A Embodiment having a water resistant polymer layer, wherein the water resistant polymer layer and the vulcanized open foam layer comprise NBR.

### Embodiment 11

The method of one of the foregoing Embodiments, wherein the a foamed polymer dispersion is made by a process comprising: (i) beginning mechanical agitation of a polymer dispersion; (ii) adding to the agitated polymer dispersion a substantial portion (about 50%) or more of the hygroscopic agent; and (iii) continuing agitation until a desired level of aeration is achieved to form the foamed polymer dispersion.

### Embodiment 12

The method of Embodiment 11, wherein anionic surfactant is added concurrently with the hygroscopic agent.

### Embodiment 13

The method of one of the foregoing Embodiments, wherein the hygroscopic agent comprises a polyhydroxylated compound of H, O and C where hydroxyls are 3 or more, the ratio of hydroxyls to carbon is 3 to 4 (3:4) or higher, and the number of carbons is 3 to about 12.

### Embodiment 14

The method of Embodiment 13, wherein the hygroscopic agent comprises glycerin.

This invention described herein is of a composite glove and methods of forming the same. Although some embodiments have been discussed above, other implementations and applications are also within the scope of the following claims. Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

What is claimed is:

1. A method of forming a composite glove with a grip texture, comprising:
providing a coagulant-coated support layer that is a fabric layer or a polymeric layer;
dip applying to the support layer a foamed polymer dispersion comprising about 0.5% to about 2.0% by weight hygroscopic agent;
allowing a portion of the applied foamed polymer dispersion to coagulate based the coagulant diffusing from the support layer to form a partially coagulated foam layer;
washing the partially coagulated foam layer to remove uncoagulated polymer to form a coagulated foam layer; and
vulcanizing the coagulated foam layer to form a vulcanized open foam layer laminated to the support.

2. The method of claim 1, wherein the support comprises a fabric, and the method further comprises:
dip applying to the fabric a second polymer dispersion configured to provide a water resistant polymer layer, and thereafter dip applying the foamed polymer dispersion.

3. The method of claim 2, wherein the fabric comprises nylon.

4. The method of claim 3, wherein the composite glove provides a dry grip of about 90 lb/in, an oil grip of about 14 lb/in, and a wet grip of about 40 lb/in or better.

5. The method of claim 4, wherein the water resistant polymer layer and the vulcanized open foam layer comprise NBR.

6. The method of claim 3, wherein the composite glove provides a dry grip of about 90 lb/in, an oil grip of about 50 lb/in, and a wet grip of about 80 lb/in or better.

7. The method of one of claim 6, wherein the water resistant polymer layer and the vulcanized open foam layer comprise NBR.

8. The method of claim 2, wherein the fabric is cut resistant and comprises an aromatic nylon.

9. The method of claim 8, wherein the fabric comprises an p-aramid nylon.

10. The method of claim 9, wherein the water resistant polymer layer and the vulcanized open foam layer comprise NBR.

11. The method of claim 6, wherein the composite glove provides a dry grip of about 65 lb/in, an oil grip of about 12 lb/in, and a wet grip of about 35 lb/in or better.

12. The method of claim 11, wherein the fabric comprises an p-aramid nylon.

13. The method of claim 12, wherein the water resistant polymer layer and the vulcanized open foam layer comprise NBR.

14. The method of claim 1, wherein the foamed polymer dispersion is made by a process comprising:
beginning mechanical agitation of a polymer dispersion;
adding to the agitated polymer dispersion a substantial portion (about 50%) or more of the hygroscopic agent; and
continuing agitation until a desired level of aeration is achieved to form the foamed polymer dispersion.

15. The method of claim 14, wherein anionic surfactant is added concurrently with the hygroscopic agent.

16. The method of claim 1, wherein the hygroscopic agent comprises a polyhydroxylated compound of H, O and C where hydroxyls are 3 or more, the ratio of hydroxyls to carbon is 3 to 4 (3:4) or higher, and the number of carbons is 3 to about 12.

17. The method of claim 1, wherein the hygroscopic agent comprises glycerin.
